(19) United States
(12) Patent Application Publication
(10) Pub. No.: US 2007/0171935 A1
(43) Pub. Date: Jul. 26, 2007

(54) Method for path and bundle locking in a video processing device

(76) Inventor: Arnd Paulsen, Darmstadt (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/590,437

(22) PCT Filed: Jan. 29, 2005
(86) PCT No.: PCT/EP05/00893

§ 371 Date: Aug. 23, 2006

(30) Foreign Application Priority Data
Feb. 26, 2004 (DE) 102004009265.6

(51) Int. Cl. H04J 15/00

(52) U.S. Cl. 370/464

(57) ABSTRACT

A method is proposed for controlling a device for the distribution of audio, video, data and control signals with respect to path and bundle locking, as well as unlocking. The device has a number of inputs and outputs which can be connected by switching and cover signal paths. The method according to the invention comprises the following steps: signal paths are completely locked and unlocked by automatic locking and unlocking, respectively, of the switching processes involved. Signal paths are joined together to form signal bundles. All of the signal paths involved are automatically locked and unlocked during the locking and unlocking, respectively, of signal bundles.

The invention relates to a method for controlling a device for the distribution of audio, video, data and control signals with respect to the locking of paths and path bundles, and their unlocking. In particular, the invention relates to a method as claimed in claim 1.

Numerous audio, video, data and control signal sources are available in television studios. These various types of signal sources include recorders, such as tape recorders, video servers, cameras and satellite or cable links. For example, different video and audio signal sources are frequently linked to one another to form an item for the production of an information transmission. A speaker in the studio typically makes the program, which is recorded by one or more cameras. The speaker introduces previously recorded items or direct transmissions. In terms of video, audio and data, these come from a source which is controlled by means of control signals. In the case of recorded items, these are called up by means of control lines which lead to the playback machine. In the case of direct transmissions, an audio line is used to command the return to the correspondent at the source.

Different signal sources can be connected to their destination by means of switching matrices. A switching matrix, which is also referred to as a crossbar, is a matrix which has a defined number of inputs and a defined number of outputs. Each input may be connected to one specific output. In particular, an input may also be connected to two or more outputs. Conversely, however, one output may be connected to only a single input.

The choice of which signals to produce at which outputs is made by an operator in the studio or control room. Connections are generally passed via a number of switching matrices and cover so-called paths. The search for paths is normally referred to as path finding and is assisted by automatic processes which are carried out by a central control unit. Despite this assistance, the operator's work remains difficult, because paths for different types of signals are switched at the same time, and thus form a logic unit, in the course of a production. A logic unit such as this is also referred to as a path bundle. It is absolutely essential to prevent the signal paths and path bundles used from being broken up, in order to prevent interference with a signal transmission.

In summary, it can be stated that the operator's work also has technical aspects in addition to the creative aspect of mixing and forming television pictures from different signal sources. On the one hand, the correct signal sources must be selected for the input side and must be passed to the correct outputs. Since there are typically more than two hundred inputs and two hundred outputs per switching matrix, this is actually rather difficult. On the other hand, the locking and unlocking of the input to output links must also be taken into account at the same time during this process, since a number of operators work in one studio or control room. For these reasons, the operator's work with respect to the use of jointly used resources and resources which are not jointly used is very demanding.

There is therefore a need to provide a method which reduces the workload on the operator as far as possible with regard to the technical aspects that have been mentioned, in order that he can concentrate on the creative aspect of his work.

This object is achieved by a method as claimed in claim 1. The method according to the invention is used to control a device for the distribution of audio, video, data or control signals. The device comprises at least one switching matrix. The switching matrix has a number of inputs, a number of outputs, and a corresponding number of coupling points for production of links between the inputs and outputs. The method comprises the following steps:
(a) selection of coupling points which are required for a signal path between an input and an output;
(b) connection of the coupling points selected in step (a) in order to produce the signal path; and
(c) locking of the coupling points in the connected state in step (b).

In one refinement of the method according to the invention, the coupling points are locked successively in the signal flow direction. In one development of the method, it is possible for the coupling points to be unlocked successively in the opposite direction to the signal flow direction.

In one expedient embodiment of the invention, two or more signal paths are combined to form a signal bundle, and are jointly locked.

According to a second aspect of the invention, a storage medium is provided in which a program code is stored which can be stored in the program memory of a data processing system and causes a program to be run which carries out the method steps in the method according to the invention.

The invention makes it easier for an operator to control a device for the distribution of audio, video, data and control signals with respect to path and bundle locking and unlocking, because the method automatically carries out a large number of functions at the machine level.

The connection of the signal path between an input and an output within a switching matrix is expediently carried out by operation of the linking function for a switching matrix. The locking of a connection in the switching matrix is locked by operation of the coupling point locking function for the switching matrix. The connection of a complete signal path is connected through two or more switching matrices by operation of the path linking function “path finding” for a higher-level entity. The locking of a complete signal path through two or more switching matrices is carried out by locking all of the coupling points involved in the signal path, that is to say by successive or parallel operation of the coupling point locking functions for all of the coupling points involved in the signal path.

One refinement of the invention describes a method in which a coupling point locking function is described for all the coupling points involved in the signal path. In particular, it is possible to provide for the coupling points to be locked successively in the signal flow direction.

In one development to the invention, this method is extended to the locking of path bundles.

These features provide the invention with the advantage that incorrect actions by a competing operator are virtually precluded, so that the work of the acting operator is not interfered with.

The drawing shows the major aspects of the method according to the invention. In the figures:

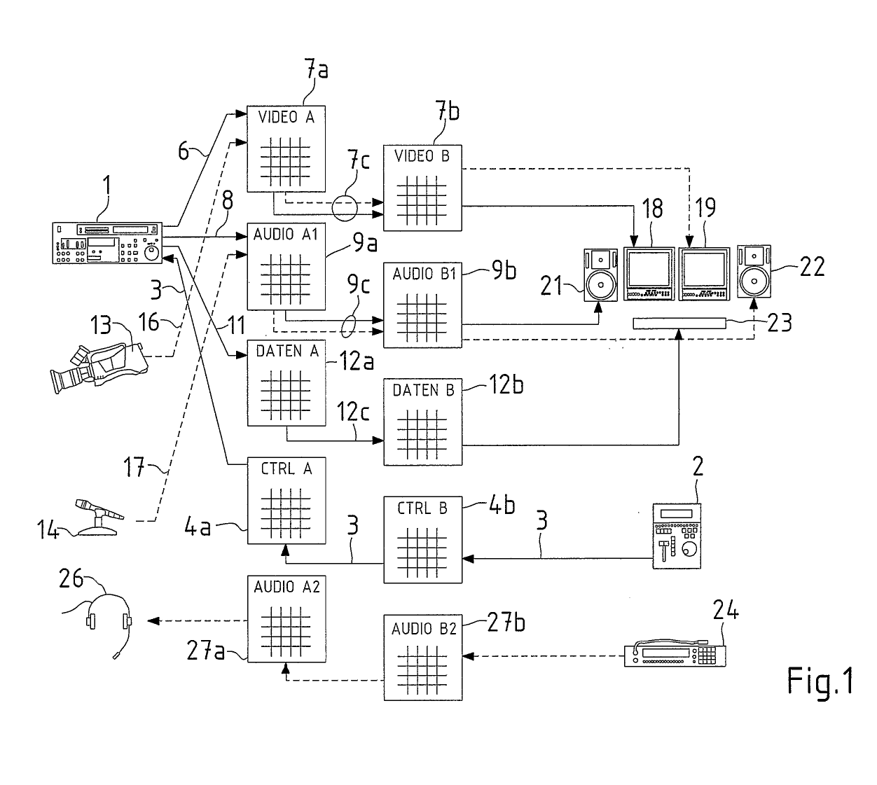

FIG. 1 shows a schematic block diagram of a television production with signal paths and the creation of a path bundle from all of the signal paths involved in the production;

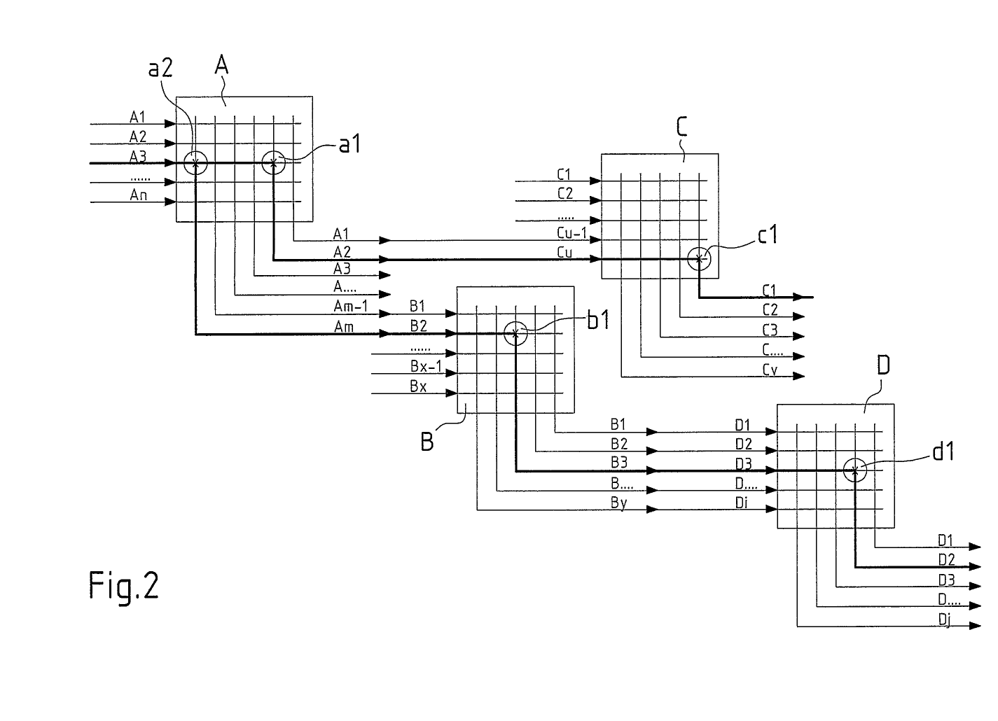

FIG. 2 shows a detailed illustration of a split signal path through a number of switching matrices; and

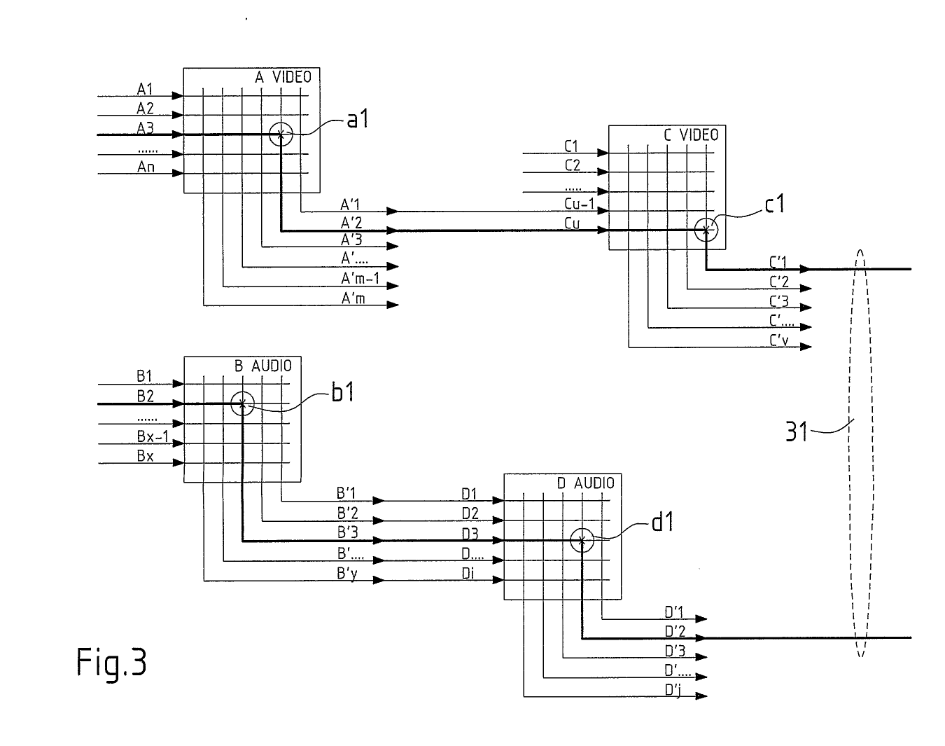

FIG. 3 shows a detailed illustration of two signal paths and the formation of a path bundle.

FIG. 1 shows a schematic block diagram of a television production, which comprises a live correspondent transmission and the playback of a recorded item. The illustrated components show a device for the distribution of audio, video, data and control signals, in which the method according to the invention can be used. The illustrated device is of only an exemplary character. The invention can also be used in devices which have fewer or more components. In this case, the components may, of course, also be of a type that is not shown in FIG. 1.

A range of different signal sources are shown on the left-hand side of FIG. 1. From top to bottom, the figure shows a tape recorder 1 from which recorded items can be called up from a control panel 2. For this purpose, the control panel 2 is connected to the tape recorder 1 via a control line 3. The control line 3 passes via two switching matrices 4a, 4b, by means of which all the required control links are switched, although FIG. 1 shows only the control line 3, for the sake of clarity.

The tape recorder 1 itself emits signals to other switching matrices. In detail, the tape recorder 1 is connected via a video line 6 to a switching matrix 7a, via an audio line 8 to a switching matrix 9a, and via a data line 11 to a switching matrix 12a. The switching matrices 7a, 9a and 12a respectively, are connected via additional connections, so-called tie lines, 7c, 9c and 12c to a respective second associated switching matrix 7b, 9b or 12b, in order to create a greater number of linking options. The tie lines may be permanently defined lines linking the switching matrices. Each switching matrix typically has 200 to 300 inputs, and precisely the same number of outputs.

Referring once again to the left-hand side of FIG. 1, the figure also shows a camera 13 and a microphone 14 for a correspondent. The camera 13 is connected via a video line 16 to the switching matrix 7a, and the microphone is connected via an audio line 17 to the switching matrix 9a.

The video signals from the tape recorder 1 and from the camera 13 are displayed separately from one another to an operator, on two video monitors 18, 19. The audio signals from the tape recorder 1 and from the microphone 14 are supplied in a corresponding manner separately to loudspeakers 21, 22 for reproduction. Finally, time code data from the tape recorder 1 is displayed on a data display. The reproduction means that have been mentioned allow an operator to produce a transmission item or a production.

Furthermore, a communication unit 24 is also available to the operator, and allows him to contact the correspondent, who is equipped with a headset/microphone unit 26. The link between the communication unit 24 and the headset/microphone unit 26 passes via two switching matrices 27a, 27b.

The production block diagram will be described only cursorily, because the described device is known from the prior art. The schematically illustrated functional blocks are commercially available, by way of example, from Thomson. Crossbars are marketed by Thomson with the product names “Trinix” and “Apex”. Thomson market tape recorders or video servers in the ranges “DCR” and “Profile”.

The numerous switching matrices throughout the entire facility are linked to a central control unit, which is not shown in FIG. 1, via command lines. The control unit is equipped with a display device on which the current status of the facility, in particular the signal paths with their locking status, are displayed. The display device is also used to assist the operator to make configuration changes in the facility, by displaying individual method steps of the control method according to the invention. Some of the major method steps will be explained in even more detail in the following text with reference to FIG. 2 and FIG. 3.

Signal paths are locked or unlocked on the basis of the method according to the invention. FIG. 2 shows, emphasized in bold, one path link, by way of example, for the sake of clarity. A signal is supplied to the switching matrix A at the input A3, and is supplied, by switching coupling point a1, via the output A2 to the switching matrix C, via the input Cu. In the switching matrix C, the signal is supplied to the output C1, by switching a coupling point c1. In addition, the signal at the input A3 is supplied via the input B2 to the switching matrix B by switching the coupling point a2 via the output Am. In the switching matrix B, this signal is supplied to the output B3 by switching a coupling point b1. Furthermore, this signal is supplied via the input D3 to the switching matrix D, which produces the signal at the output D2 by switching a coupling point d1.

Various situations will now be explained with reference to this example of a signal path:
(1) The coupling points which are involved in the path automatically determine that a signal path has been locked in the signal flow direction, initiated at the start of the path, and lock all of them in a successive or parallel process. The locking of the path starting from the input A3 in the signal flow direction locks the following coupling points: a2, a1, c1, b1, d1.
(2) The locked coupling points which are involved with the path automatically determine that a lock in the signal flow direction, initiated at the start of the path, has been cancelled, and unlock all of them in a successive or parallel process. The unlocking of the path according to (1) starting from the input A3 in the signal flow direction unlocks the following coupling points: a2, a1, c1, b1, d1.
(3) The coupling points involved in the path automatically determine a signal path as being locked in the opposite direction to the signal flow direction, initiated at the end of the path, and automatically lock all of them in a successive or parallel process. The locking of the path in the opposite direction to the signal flow direction starting from the output D2 locks the following coupling points: d1, b1, a2.
(4) The locked coupling points involved with the path automatically determine that a lock in the opposite direction to the signal flow direction, initiated at the end of the path, has been cancelled, and unlock all of them in a successive or parallel process. The unlocking of the path according to (3) in the opposite direction to the signal flow direction, starting from the output D2, unlocks the following coupling points: d1, b1, a2.
(5) The coupling points which are involved in the path in the signal flow direction automatically determine that a signal path has been locked in the signal flow direction, initiated in the middle of the path, and lock all of them in a successive or parallel process. The locking of the path in the signal flow direction starting from the input B2 locks the following coupling points: b1, d1.
(6) The locked coupling points which are involved in the path in the signal flow direction automatically determine that a lock in the signal flow direction, initiated in the middle of the path, has been cancelled, and unlock all of them in a successive or parallel process. The unlocking of the path according to (5) in the signal flow direction, starting from the input B2, unlocks the following coupling points: b1, d1.
(7) The coupling points which are involved in the path in the opposite direction to the signal flow direction automatically determine locking of a signal path in the opposite direction to the signal flow direction, initiated in the middle of the path, and lock all of them in a successive or parallel process. The locking of the path in the opposite direction to the signal flow direction, starting from the input D3, locks the following coupling points: b1, a2.
(8) The locked coupling points which are involved in the path in the opposite direction to the signal flow direction automatically determine the cancellation of a lock in the opposite direction to the signal flow direction, initiated in the middle of the path, and unlock all of them in a successive or parallel process. The unlocking of the path according to (7) in the opposite direction to the signal flow direction, starting from the input D3, unlocks the following coupling points: b1, a2.

One particular advantage of the method according to the invention is that the operator is largely freed of monitoring and control tasks at the machine level and can concentrate on the creative aspect of his work.

In a development of the invention, the described advantage is further supported by the capability to produce or cancel path bundles and to lock and unlock path bundles.

FIG. 3 shows the method used for locking and unlocking signal bundles. Signal paths which can be selected are joined together to form a path bundle or a path group. This means that the signal paths which initially run independently of one another are linked to one another for a video link and an audio link to a logic unit. The number of signal paths may also be greater or less than this in other exemplary embodiments.

The following text describes a number of situations which relate to the locking and unlocking of path bundles.
(9) The grouping of signal paths to form a path bundle is carried out by entry in a list of at least one input or output of a signal path to be added to the group. The production of a path bundle 31, as illustrated in FIG. 3, is carried out by entering the outputs C1 and D2 in a following list {output C1, output D2}.
(10) The grouping of signal paths to form path bundles can be modified by deletion of individual entries from the list according to (9). If there are no entries in the list, then the path bundle is cancelled.
(11) The locking of a path bundle is independent of the way in which the bundle has been formed, which may also be done in a different way to that according to (9). The locking of a path bundle is carried out by locking the paths contained in the bundle according to (1), (3), (5), (7). The grouping of the signal paths to form the signal bundle can then likewise not be modified according to (10).
(12) The unlocking of a path bundle is carried out in the same way as its locking independently of the way in which the bundle is formed. A path bundle is unlocked by first of all cancelling the grouping of the signal paths to form the path bundle according to (10). After this, all of the paths contained in the bundle are unlocked according to (2), (4), (6), (8).

The steps (11) and (12) make it clear that the locking of a path bundle is an additional characteristic of the path bundle, with the consequence that all of the signal paths which belong to the path bundle are locked. This means that both the path bundle as an entity and the individual signal paths which belong to the path bundle are locked.

A modification of the invention provides for the locking of a path bundle to prevent only the modification of the grouping of signal paths to form a bundle. The locking state at the time of grouping of each individual signal path is maintained, and, however, cannot be changed until the bundle lock is cancelled.

In developments of the invention, warning information is also displayed to the operator if he attempts to carry out an impermissible action.

1. A method for controlling a device for the distribution of audio, video, data or control signals, with the device having at least one switching matrix, which has a number of inputs and a number of outputs as well as a corresponding number of coupling points for production of links between the inputs and outputs, with the method comprising the following steps:
(a) selection of coupling points which are required for a signal path between an input and an output;
(b) connection of the coupling points selected in step (a) in order to produce the signal path; and
(c) locking of the coupling points in the connected state in step (b).

2. The method as claimed in claim 1, wherein the coupling points are successively locked in the signal flow direction.

3. The method as claimed in claim 1, wherein the coupling points are locked in the opposite direction to the signal flow direction.

4. The method as claimed in claim 2, wherein the coupling points are unlocked in the signal flow direction.

5. The method as claimed in claim 2, wherein the coupling points are successively unlocked in the opposite direction to the signal flow direction.

6. The method as claimed in claim 1, wherein two or more signal paths are combined to form a signal bundle, and are jointly locked.

7. The method as claimed in claim 6, wherein the process of joining two or more signal paths together to form a path bundle is carried out by the entry of input or outputs for the respective signal paths in a list.

8. The method as claimed in claim 7, wherein the locking of the path bundle is carried out by locking the process of joining the path bundle together as well as by the locking of all signal paths which have been joined together to form the path bundle.

9. The method as claimed in claim 7, wherein the path bundle is cancelled by deletion of all the inputs and outputs from the list.

10. The method as claimed in claim 6, wherein locked signal paths which have been joined together to form a locked path bundle cannot be unlocked.

11. The method as claimed in claim 10, wherein the attempt to unlock a locked signal path which is part of a path bundle initiates the indication of a warning message.

12. A storage medium in which a program code is stored which can be stored in the program memory of a data processing system and causes a program to be run which carries out the method steps as claimed in claim 1.
